(19) United States
(12) Patent Application Publication
(10) Pub. No.: US 2005/0011995 A1
(43) Pub. Date: Jan. 20, 2005

(54) Cable keeper

(76) Inventor: Orlando de Guevara, Toluca Lake, CA (US)

Correspondence Address: Kevin M. Able, 2825 Hickock Rd., Corning, NY, 14830, US

(21) Appl. No.: 10/621,876

(22) Filed: Jul. 16, 2003

(51) Int. Cl. F16L 3/22

(52) U.S. Cl. 248/68.1

(57) ABSTRACT

Disclosed is a cable keeper for organizing and retaining computer-related data and power cables. In one embodiment, the cable keeper is rectangular in shape and comprised of a sheet of flexible material. The cable keeper is further comprised of openings arranged along an edge of the cable keeper, and slots connecting the openings to an edge to allow the passage of a computer cable into the opening. The openings are sized to fit a computer cable, but also to prevent the passage of a cable connector such that a cable connector located on the end of a cable is unable to pass through the opening. Thus, the cable end may be retained by the cable keeper in a convenient position for future re-connection. The cable keeper is also provided with an adhesive strip for adhering the cable keeper to an object.

### BACKGROUND OF THE INVENTION

1. Field of the Invention

The invention relates to computer equipment, and more specifically to a cable keeper for organizing and holding computer and computer peripheral cables.

2. Technical Background

Computers are ubiquitous. Having moved from room-sized enclosures to hand-held devices and smaller, there is virtually not an aspect of daily life that is not touched by computers in one way or another. The markets for computing equipment, and in particular so-called personal, or desktop, computers (PCs) and more portable laptop computers have undergone significant growth over the last decade. Both desktop and laptop computers can be found in home, office and educational environments. Unfortunately, the growth in the number of such computing devices has been matched and exceeded by the amount of peripheral equipment that is or can be commonly attached to the processing unit/enclosure. Peripheral equipment includes input devices such as keyboards and “mice”, scanners, printers, data storage devices, and monitors as well as related data and power cables. The need for peripheral devices, and the accompanying proliferation in cables leading to and from the processor enclosure and power sources, has resulted in a virtual jungle of cables.

To overcome this tangle of electrical and electronic pathways, specially-designed furnishings, such as, for example, computer desks, have been introduced to provide ergonomically correct access to the processor enclosure and peripheral devices. Some of the more elaborate designs may include, for example, cable pass-through ports located in the top of the desk. The appropriate cables, for example the cables to a monitor located on the desktop, are threaded through the pass-through to the processor enclosure and the power outlet. Other desks are provided with raceways that guide the cables through various channels built into the desks. In spite of these advancements, such desks are expensive, and threading the cables through such openings and channels is burdensome, particularly if equipment must be frequently moved and/or re-configured.

In a frequent scenario found in office or educational environments, desktop PCs, in in some cases laptop computers, or individual peripheral devices, are moved, either for replacement or personnel relocation. Frequently, the desk or table on which the peripheral devices rest has no built-in cable routing. When the cables connecting the peripheral devices to the processor enclosure are disconnected, they typically fall to the floor. This can prove to be burdensome in an environment where such changes occur often.

### SUMMARY

In one embodiment, the cable keeper according to the present invention comprises a sheet of flexible material having at least one edge, a plurality of openings spaced adjacent to the edge, each opening having a slot extending between the opening and the the edge to allow a passage of one or more cables, and an adhesive disposed on the sheet for adhering the cable keeper to an object.

Preferably, the cable keeper is comprised of cardboard stock, more preferably a polymer. Preferably the polymer is selected from the group consisting of polyester, polypropylene and polyethylene.

Preferably the adhesive is comprised of an acrylic, more preferably a synthetic rubber. Preferably, the adhesive is protected by a releasable liner.

In another embodiment, at least a portion of the cable keeper according to the present invention has a circular shape.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is rear view of a typical computer setup, showing peripheral devices and the cable keeper according to one embodiment.

FIG. 2 is a side view of the computer setup showing peripheral devices and the cable keeper according to one embodiment.

FIG. 3 is an illustration of one embodiment of the cable keeper according to the present invention.

FIG. 4 is an edge view of one embodiment of the cable keeper according to the present invention.

FIG. 5 is an illustration of a cable connector attached to a cable.

FIG. 6 is an illustration of another embodiment of the cable keeper according to the present invention wherein the cable keeper is formed in a long length.

FIG. 7 is an illustration of another embodiment of the cable keeper according to the present invention wherein the cable keeper has a circular shape.

FIG. 8 depicts another embodiment of the cable keeper according to the present invention wherein at least a portion of the cable keeper has a circular shape.

### DETAILED DESCRIPTION

In the following, preferred embodiments of the cable keeper in accordance with the present invention will be explained in detail with reference to the drawings. In the explanation of the drawings, constituents identical to each other will be referred to with numerals or letters identical to each other, without repeating their overlapping descriptions. Also, ratios of sizes in the drawings do not always coincide with those explained.

Although various tables, desks, cabinets and other furniture pieces have been designed to accommodate computers and related peripheral equipment, such furniture pieces do not all provide a means for organizing and retaining the data cables and power cables associated with the computer equipment. In addition, such specialized pieces of furniture tend to be expensive compared to their non-computer counterparts, making their use financially burdensome, particularly in environments where a large number of computers are deployed. Thus, often the furniture piece on which the processor enclosure or peripheral device rests has no built-in cable routing or restraint. Consequently, not only do the various processor enclosures, monitors, disk drives, printers, scanners, keyboards and other devices consume considerable space on a given work surface, but the multiple associated data and power cables soon become an unruly tangle. The cable keeper according to the present invention is intended as an inexpensive, easily employed means of bringing much-needed organization to the proliferation of various computer-related cables without the need to resort to more elaborate, specialized furnishings. Additionally, if a cable that connects a peripheral device to the processor enclosure, or one peripheral device to another, or in any event that passes through the cable keeper according to the present invention is disconnected, the connector at an end of such cable is stopped from passing through the opening in the cable keeper. As a result, the cable is held by the cable keeper in a location convenient for re-connection rather than dropping to the floor, under or behind a furnishing. One example of such a situation is a laptop computer, wherein the laptop computer, being disposed on the surface of a desk, is connected to an external power supply, and one or more peripheral devices. The portable laptop is disconnected from the power supply and peripheral devices by disconnecting the power supply and peripheral device cables, and removed from the table. The cables are prevented from falling to the floor by the cable keeper, and are in a ready position to be re-connected to the laptop computer when the computer is returned. Such a scenario frequently occurs in an office or educational environment, most often during the personnel relocations. In such instances, computer peripheral devices, the processor enclosure, or all such components may require replacement or otherwise be moved to another location.

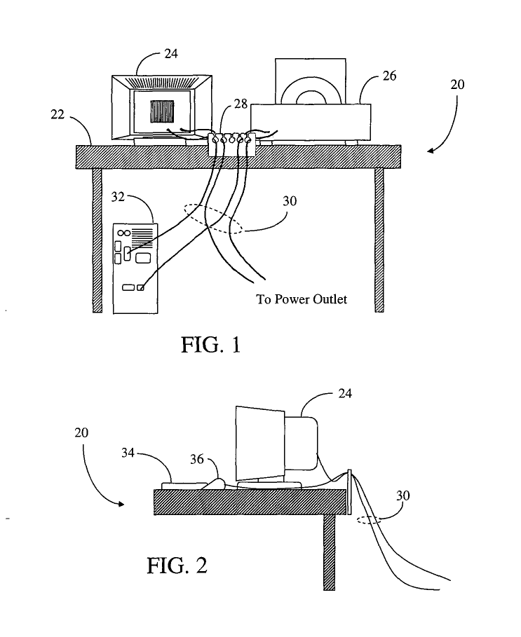

A typical layout of a minimal amount of computer equipment on the top work surface of a table is illustrated in FIG. 1. FIG. 1 shows a rear view of table 20 supporting on its top work surface 22 a computer monitor 24 and printer 26. Preferably, the layout would include a keyboard and “mouse” (not shown in FIG. 1). A preferred embodiment of the cable keeper 28 according to the present invention is shown attached to the back edge of table 20. Data and power cables 30 are shown exiting both monitor 24 and printer 26 and passing through cable keeper 28. Such cables either terminate at the processor enclosure 32, or at a power outlet (not shown). Processor enclosure 32 typically comprises the central processing unit (CPU) mounted on a so-called motherboard, one or more magnetic data storage devices (“hard drives”), and one or more optical data storage or retrieval drives (such as compact disk drives), and an internal power supply/regulator for the motherboard, CPU and other components typically, although not exclusively, located within the processor enclosure. FIG. 2 shows an end view of table 20, along with computer monitor 24. Also shown in FIG. 2 are computer keyboard 34 and “mouse” 36 (in this context a “mouse” refers to a hand-held input device used to control, inter alia, a cursor on the computer monitor). In FIG. 2, cable keeper 28 is shown attached vertically to the vertical back edge of table 20. Also shown are several computer cables 30 passing from monitor 24 and mouse 36 through cable keeper 28. It will be readily apparent that cable keeper 28 could be easily attached to table 20 in other orientations, such as, for example, in a horizontal configuration to the top work surface 22 of table 20.

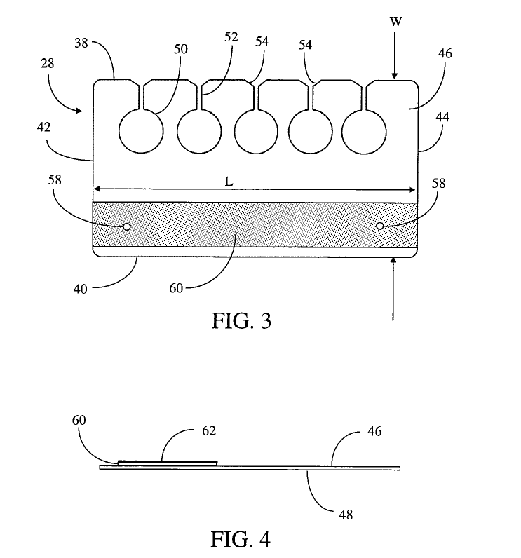

Referring to FIG. 3, the cable keeper 28 according to one embodiment is comprised of a sheet of flexible material having a rectangular shape defined by a width W between a first side edge 38 and a second side edge 40, and a length L between a first end edge 42 and a second end edge 44. Cable keeper 28 is further comprised of a first face 46 and a second face 48 (shown in FIG. 3), and a plurality of openings 50 between the first face 46 and the second face 48 therethrough, the openings 50 being sized to fit at least one computer and/or computer peripheral device data and/or power cable, and also sized to prevent the passage of a cable connector disposed on at least one end of cable 30. Openings 50 are arranged adjacent to the first side edge 38 of cable keeper 28. Preferably length L of cable keeper 28 is less than about 25 cm, more preferably less than about 15 cm, most preferably less than about 10 cm. Preferably, the aspect ratio of cable keeper 28, that is, length L divided by width W, is greater than 1. Preferably, cable keeper 28 is comprised of a cardboard stock, more preferably a polymer. Preferred polymers include, for example, polyester, polyethylene or polypropylene. A slot 52 extends from each opening 50 to the first side edge 38 such that at least one computer cable 30 may pass through slot 52 into opening 50. Preferably, the first side edge 38 of cable keeper 28 has a chamfer 54 at each side of slot 52 to facilitate guiding a cable 30 into and through slot 52.

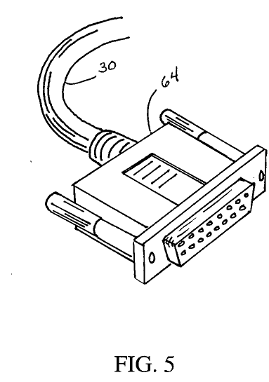

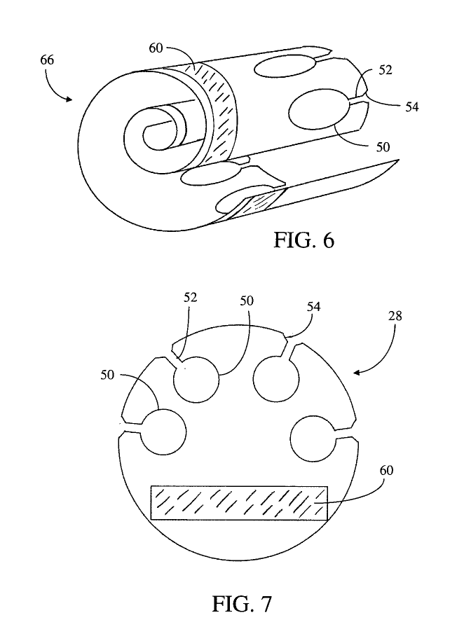

In one embodiment, cable keeper 28 is attached to a selected furnishing by mechanical fastening through “nail” openings 58. Any suitable mechanical fastener may be employed that can pass through openings 58 such as nails or thumbtacks. Obviously, such fasteners are effective only in mounting cable keeper 28 on an object into which the fastener can be driven, for example a wooden desk. However, such methods of fastening also tend to damage the furnishing. In a preferred embodiment, a pressure sensitive adhesive strip 60 is provided on a first face 46 of cable keeper 28 generally adjacent to and parallel with the second side edge 40 and opposite first side edge 38. Adhesive strip 60 is preferably covered with a releasable liner 62 (shown in FIG. 4) to prevent inadvertent adhesion.

In a preferred embodiment, adhesive strip 60 comprises a double-sided adhesive tape wherein one side of the tape is applied to first face 46 in the location previously described. The opposite, otherwise exposed side of the tape is protected by releasable liner 62. Such adhesive tapes are generally comprised of an elongated flexible backing material and an adhesive which has been applied to one or both sides of the backing material. FIG. 4 depicts an end edge view of cable keeper 28 showing adhesive strip 60 and releasable liner 62. Because computer furnishings are constructed from a variety of materials, adhesive strip 60 must be capable of adhering to a variety of surfaces with high adhesion, including, for example, wood, metal and plastic. In addition, because cable keeper 28 is preferably comprised of low surface energy polymers such as polyethylene, the preferred adhesive comprising adhesive strip 60 must also be capable of adhering to such low surface energy materials. Examples of suitable adhesive tapes include 3MTM Double Coated Tape 444, employing an acrylic adhesive on a polyester backing, and 3M™ Double Coated Tape 9443, employing a synthetic rubber adhesive on a polypropylene backing. 3MTM Double Coated Tape 444, for example, has an adhesive strength of about 47 N/100 mm when tested according to ASTM 3330 after 72 hours at room temperature and at an angle of 90 degrees on polypropylene, and 66 N/100 mm on polyester and stainless steel. 3M™ Double Coated Tape 9443, on the other hand, has an adhesive strength of 110 N/100 mm on steel. For added adhesion, the adhesive preferably should have an adhesive strength greater than about 80 N/100 mm, such as, for example, 3M Adhesive Transfer Tape 9453, 9471 or 9472. These adhesive tapes comprise a high-strength acrylic adhesive on a polycoated kraft liner. Transfer tape 9472 is rated to have an adhesive strength of 81 N/100 mm when tested in accordance to ASTM 3330 after 72 hours at room temperature and at an angle of 90 degrees on polypropylene, and 82 N/100 mm on stainless steel, whereas 3M Adhesive Transfer Tape 9472 is rated to have an adhesive strength of 149 N/100 mm on polypropylene and 153 N/100 mm on stainless steel. Preferably, the adhesive strength of the adhesive is at least 45 N/100 mm, more preferably greater than about 80 N/100 mm, and most preferably greater than about 100 N/100 mm. Although an adhesive tape is preferred, those skilled in the art will recognize that other adhesive choices can be made, such as, for example, an adhesive applied as a liquid.

To deploy the cable keeper according to the present invention when an adhesive strip is used, releasable liner 62 is peeled away from adhesive strip 60, exposing adhesive strip 60. Cable keeper 28 is then pressed against the desired surface, such as, for example, an edge of table 20, such that exposed adhesive strip 60 is in contact with the surface to which cable keeper 28 is to be attached. It should be noted that cable keeper 28 need not be used only in conjunction with a table edge. Cable keeper 28 may be easily deployed on a variety of different surfaces and furnishings as the need arises. For example, cable keeper 28 may be easily deployed on a table leg, the side of a cabinet, or anywhere cable organization and retention is desired. Cable keeper 28 may be deployed in any number of orientations, including horizontally and vertically. Furthermore, cable keeper 28 need not be restricted to use for computer data and power cables. For example, cable keeper 28 is also useful for such applications as the organization and retention of sound and/or video recording and playback equipment cables. Such equipment comprises amplifiers, tuners, phonographs, tape players, compact disc (CD) players, equalizers, Digital Video Disc players (DVD), televisions, video tape players and others.

Once cable keeper 28 has been adhered in a suitable location for organizing and retaining the desired cable or cables, the cables are inserted into cable keeper 28 by pressing a selected cable or cables 30 between chamfers 54 into slot 52. The sides of slot 52 bend aside, enlarging slot 52 sufficiently to allow the cable to pass through slot 52 into opening 50. Additional cables are inserted into one or more slots, as needed, in the manner just described. Computer cables (both data and power cables) typically are configured with a connector located at one or both ends of the cable to facilitate mating with a corresponding connector on a piece of equipment. A typical connector 64 located at the end of a cable 30 is depicted in FIG. 5. Openings 50 are preferably sized such that connector 64 is unable to pass through an opening 50. In this instance, connector 64, and therefore cable 30, being disconnected from a peripheral device, will be retained by opening 50 at the cable keeper 28, placing cable 30 and connector 64 in a convenient location for re-connection.

In another embodiment, the length L of cable keeper 28 is much longer than width W of cable keeper 28, forming a long length cable keeper 66 which may be conveniently rolled for storage, as illustrated in FIG. 5. In this embodiment, individual shorter cable keepers 28 of a desired length can be cut from long length cable keeper 66. Preferably, long length cable keeper 66 has an aspect ratio greater than 5, more preferably greater than 20, more preferably greater than 50.

The cable keeper according to the present invention may be manufactured by any suitable method. For example, the cable keeper may be die-cut from an appropriately-sized blank of the flexible material, or it may be injection molded. The choice of manufacturing method is dictated somewhat by the choice of flexible material. For example, the use of cardboard stock necessitates a method employing cutting, such as die cutting (stamping), whereas the choice of a polymer as the flexible material allows either die-cutting or injection molding. Preferably, cable keeper 28 or long length cable keeper 66 is manufactured by injection molding, more preferably by die-cutting.

It should be understood that cable keeper 28 may be manufactured in shapes other than rectangular. For example, cable keeper 28 could comprise a circular shape having a plurality of openings along at least a portion of the edge at the outer circumference of the cable keeper as shown in FIG. 7. FIG. 7 shows one embodiment of a circular cable keeper according to the present invention, including a preferred placement of adhesive strip 60. In this embodiment, cable keeper 28 is comprised of a flexible material having a generally circular shape. Cable keeper 28 is further comprised of a plurality of openings 50 arranged adjacent to at least a portion of the edge at the outer circumference of cable keeper 28. As in the previous embodiment, slots 52 connect openings 50 to the outer circumference of cable keeper 28. Slots 52 have chamfers 54 at each side of slots 52 at the outer circumference of cable keeper 28. Cable keeper 28 according to the present embodiment has an adhesive strip 60 as in the previous embodiment. Preferably adhesive strip 60 is located across a chord of the generally circular cable keeper of the embodiment.

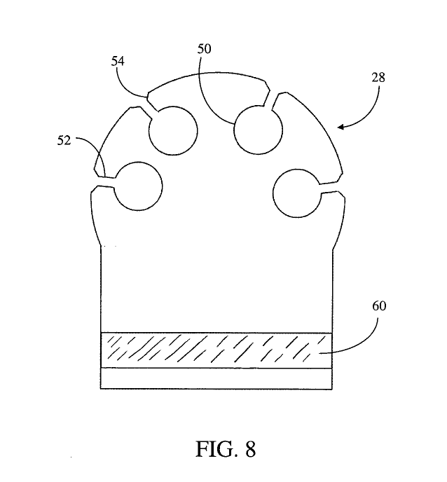

In yet another embodiment, cable keeper 28 may comprise a combination of shapes, such as, for example, at least a portion of a rectangle and at least a portion of a circle, as shown in FIG. 8. As in the previous embodiments, the cable keeper according to the present embodiment is configured with openings 50 along the edge of the portion of a rectangle or the edge at the outer circumference of circle of the cable keeper 28, slots 52 to allow passage of at least one cable 30, chamfers 54 on each side of slots 52 to aid in placing the cables 30 into and through the slots 52, and an adhesive strip 60.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A cable keeper comprising:
a single sheet of flexible material having at least one edge and a plurality of openings spaced adjacent to the edge, each opening having a slot extending between the opening and the edge to allow a passage of at least one cable; and
an adhesive disposed on a face of the sheet for adhering the cable keeper to an object.

2. The cable keeper according to claim 1 wherein the cable keeper is comprised of a polymer.

3. The cable keeper according to claim 2 wherein the polymer is selected from the group consisting of polyester, polyethylene and polypropylene.

4. The cable keeper according to claim 1 wherein the sheet is comprised of cardboard stock.

5. The cable keeper according to claim 1 wherein the adhesive is applied to the sheet as a liquid.

6. The cable keeper according to claim 1 wherein the adhesive is an adhesive tape.

7. The cable keeper according to claim 6 wherein the adhesive is selected from the group consisting of an acrylic and a synthetic rubber.

8. The cable keeper according to claim 1 further comprising a releasable liner to prevent inadvertent adhesion.

9. The cable keeper according to claim 1 wherein each slot is chamfered.

10. The cable keeper according to claim 1 further comprising a length L where L is less than about 25 cm.

11. The cable keeper according to claim 10 wherein L is less than about 15 cm.

12. The cable keeper according to claim 1 further comprising a length L where L is greater than about 25 cm.

13. The cable keeper according to claim 12 wherein L is greater than about 1 meter.

14. The cable keeper according to claim 11 further comprising an aspect ratio greater than about 1.

15. The cable keeper according to claim 12 further comprising an aspect ratio greater than about 5.

16. The cable keeper according to claim 13 further comprising an aspect ratio greater than about 20.

17. The cable keeper according to claim 1 wherein at least a portion of the sheet is circular.

18. The cable keeper according to claim 6 wherein the adhesive has an adhesive strength greater than about 80 N/100 mm.

19. The cable keeper according to claim 6 wherein the adhesive has an adhesive strength greater than about 100 N/100 mm.
